(19) United States
(12) Patent Application Publication
(10) Pub. No.: US 2010/0259774 A1
(43) Pub. Date: Oct. 14, 2010

(54) IMAGE FORMING CONDITION SETTING DEVICE AND IMAGE FORMING CONDITION SETTING METHOD

(75) Inventors: Yoshikatsu Kamisuwa, Tokyo-to (JP); Hiroyo Katou, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/755,708

(22) Filed: Apr. 7, 2010

Related U.S. Application Data
(60) Provisional application No. 61/169,086, filed on Apr. 14, 2009.

(51) Int. Cl. G06F 15/00

(52) U.S. Cl. 358/1.9

(57) ABSTRACT

An image forming printing condition setting device for setting an image forming condition displays setting candidates including combinations of plural types of setting conditions, generates a new setting candidate similar to a selected setting candidate if the setting candidate is selected from the displayed setting candidates, and displays the selected setting candidate and the generated new setting candidate similar to the selected setting candidate.

### CROSS-REFERENCE TO RELATED APPLICATION

This application claims the benefit of U.S. Provisional Application No. 61/169,086, filed Apr. 14, 2009.

### TECHNICAL FIELD

The present invention relates to an image forming condition setting device and an image forming condition setting method of setting printing conditions in a multi-function image forming apparatus such as a digital multi-function peripheral.

### BACKGROUND

In recent years, image forming apparatuses such as digital multi-function peripherals have increased in the number of functions. The multi-function image forming apparatuses can perform a printing operation with a complex condition in which plural printing conditions are combined. For example, some digital multi-function peripherals have a stapling function, a punching function, and the like which take a time in manual. In such digital multi-function peripherals, the stapling function, the punching function, and the like can be performed by causing a user to input setting details to an operation screen. Some digital multi-function peripherals can perform image quality adjusting functions such as brightness correction, contrast correction, color concentration correction, and fine line clearing as functions of correcting an image of an original document. The setting details of such image quality adjustment can be instructed and input on the operation screen by a user.

However, since the number of setting items increases with an increase in the number of functions or an improvement in function quality of the digital multi-function peripherals, the setting details are complicated. For example, in some digital multi-function peripherals, several tens of setting items may be often set on a single operation screen (setting screen). Accordingly, some users poor at operation thereof may suffer from mental pains in operating the complicated setting screen or may not satisfactorily use various functions of the digital multi-function peripherals.

To improve the operability in the above-mentioned complicated settings, a technique of determining recommended settings on the basis of a user's setting frequency and providing the user with the recommended settings if the user's print settings are different from the recommended settings is disclosed, for example, in JP-A-2000-172469. However, users do not print some images for a determined purpose, but may change the settings depending on the print objects. Accordingly, it is difficult to provide the recommended settings necessarily corresponding to the users' desires, only by determining the recommended settings on the basis of the setting frequency.

### SUMMARY

According to an aspect of the invention, there is provided an image forming condition setting device for setting an image forming condition, the apparatus comprises a candidate generator configured to generate a new setting candidate similar to a selected setting candidate if one setting candidate is selected from setting candidates including combinations of a plurality of types of setting conditions and a display controller configured to display the selected setting candidate and the new setting candidate similar to the selected setting candidate and generated by the candidate generator.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating a hardware configuration of a digital multi-function peripheral 1 as an image forming apparatus.

FIG. 2 is a diagram illustrating an example of a simple setting screen.

FIG. 3 is a diagram illustrating an example of plural setting candidates generated on the basis of a single setting candidate.

FIG. 4 is a flowchart illustrating a flow of processes of generating a setting candidate of a vector close in distance to the vector of the selected setting candidate.

FIG. 5 is a flowchart illustrating a flow of a setting candidate selecting process.

FIG. 6 is a diagram illustrating a first example of an object simple setting screen.

FIG. 7 is a diagram illustrating a second example of the object simple setting screen.

FIG. 8 is a flowchart illustrating a flow of the setting candidate selecting process on the object simple setting screen.

FIG. 9 is a diagram illustrating an example of an image quality setting screen.

### DETAILED DESCRIPTION

Hereinafter, embodiments of the invention will be described with reference to the accompanying drawings.

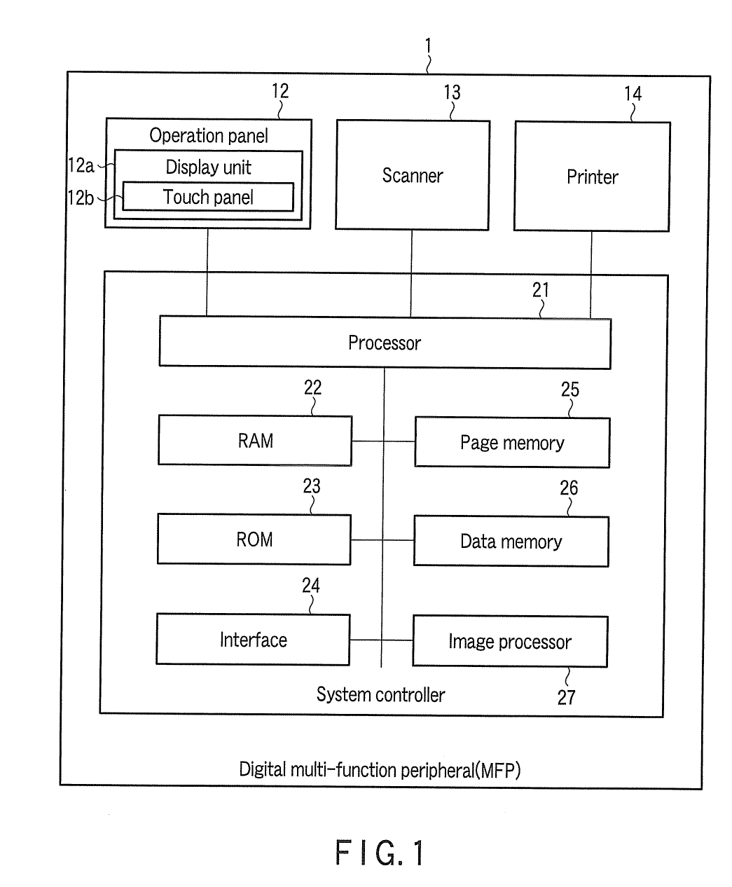

FIG. 1 is a diagram illustrating a hardware configuration of a digital multi-function peripheral 1 as an image forming condition setting device.

As shown in FIG. 1, the digital multi-function peripheral (MFP) 1 includes a system controller 11, an operation panel 12, a scanner 13, and a printer 14.

The system controller 11 controls the entire operation of the digital multi-function peripheral 1. The system controller 11 is connected to the operation panel 12, the scanner 13, and the printer 14. According to this configuration, the system controller 11 receives an operation instruction input to the operation panel 12 and controls the scanner 13 and the printer 14.

The operation panel 12 is a user interface to which a user's operation instruction is input. The operation panel 12 includes hard keys such as numerical keys and a display unit 12a having a built-in touch panel 12b. Operation guidance or touch keys which can be selected using the touch panel 12b are displayed on the display unit 12a of the operation panel 12. In the operation panel 12, the input to the touch keys displayed on the display unit 12a is sensed by the use of the touch panel 12b. For example, setting information of various functions specified by a user is input using the operation panel 12 and is sent to the system controller 11.

The scanner 13 converts an image of an original document into image data. The scanner 13 converts the image of an original document into color or black-and-white digital image data. The printer 14 forms an image on a sheet as an image forming medium. The printer 14 has printing functions of black-and-white printing, color printing, bicolor printing, double-side printing, and the like. The printer 14 has sheet processing functions such as stapling and punching.

The system controller 11 includes a processor 21, a RAM (Random Access Memory) 22, a ROM (Read Only Memory) 23, an interface 24, a page memory 25, a data memory 26, and an image processor 27.

The processor 21 controls the entire operations of the system controller 11. The processor 21 embodies various processes or various functions by operating on the basis of a control program. The RAM 22 is a memory temporarily storing work data or storing reference data. The ROM 23 is a nonvolatile memory. The ROM 23 stores, for example, control programs and control data for controlling the digital multi-function peripheral 1. The interface 24 makes data communications via a network not shown. The page memory 25 is a memory having a memory area for developing image data corresponding to at least one page. The data memory 26 is also used as a memory for backing up various data and stores various setting data or management data. The data memory 26 is constructed, for example, by an HDD.

The image processor 27 serves to perform a variety of image processing on the image data. The image processor 27 includes an image processing circuit. The image processor 27 performs image processing such as image magnification, image rotation, image layout correction, image quality correction, and compression and decompression. The image correction of the image processor 27 is set by plural types of parameters. For example, fine line, halftone, color concentration, sharpness, brightness, contrast, saturation, and the like can be set as the image correcting parameters.

In the digital multi-function peripheral 1 having the above-mentioned configuration, various functions to be described later are embodied by causing the processor 21 to execute the control program stored in the ROM 23 or the data memory 26. In other words, the functions to be described later may be embodied by causing the processor 21 of a personal computer to execute the control program. That is, the functions to be described later may be applied to a printer driver which operates in a computer such as a personal computer.

A printing condition setting process in the digital multi-function peripheral 1 will be described below.

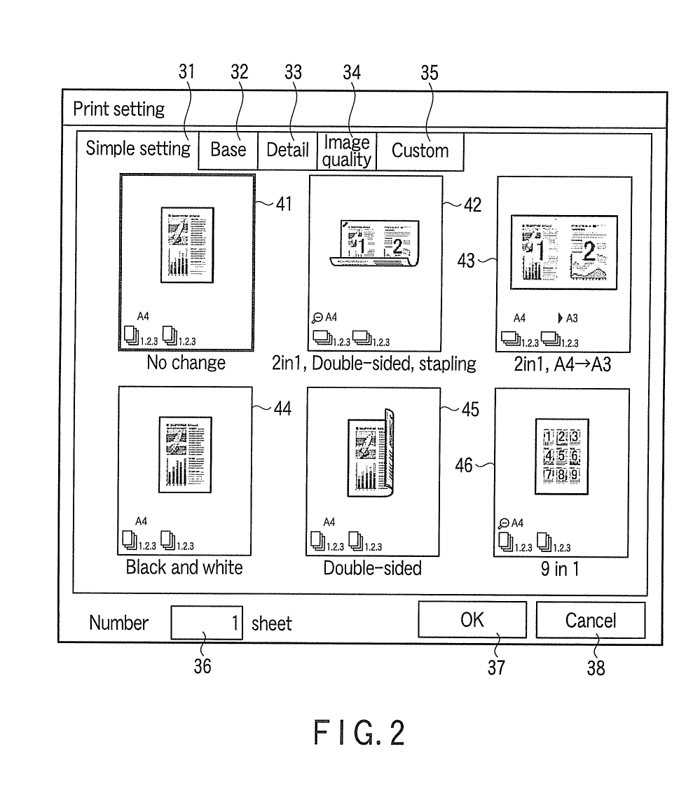

FIG. 2 is a diagram illustrating an example of a display of a setting screen displayed on the display unit 12a of the operation panel 12.

As shown in FIG. 2, the display unit 12a displays plural tabs such as a “simple setting” tab 31, a “base” tab 32, a “detail” tab 33, an “image quality” tab 34, and a “custom” tab 35 as a print setting menu. A user selects a tab corresponding to a setting method or setting details from the tabs. In the example shown in FIG. 2, the setting screen (simple setting screen) in a state where the simple setting tab 31 is selected is shown. The simple setting screen shown in FIG. 2 is to cause the user to select one setting candidate (a combination of various setting conditions) from the setting candidates including combinations of various setting conditions.

In the simple setting screen shown in FIG. 2, plural preview images representing the setting candidates including plural types of combinations of setting conditions are displayed. In the simple setting screen shown in FIG. 2, a display frame 36 representing the number of sheets to print, an “OK” button 37 for instructing to determine the selected details, and a “cancel” button 38 for instructing to cancel the selected details are also displayed.

In the example shown in FIG. 2, six preview images 41 to 46 are displayed as the preview images representing plural setting candidates. The preview images 41 to 46 are images representing various setting conditions in the setting candidates and are icons (touch keys) which can be selected using the touch panel 12b. The preview images 41 to 46 express a variety of setting conditions with character information and express the processing results under the setting conditions in images.

The preview image 41 represents the setting candidate of “No change (all printing conditions are set to defaults”. The preview image 42 is a setting candidate including “2in1 (to print two image on a single sheet), double-sided, stapling” as the printing conditions. The preview image 43 is a setting candidate including “2in1, A4->A3 (to print an original image with A4 size on an A3-sized sheet)” as the printing conditions. The preview image 44 is a setting candidate including “black and white” as the printing condition. The preview image 45 is a setting candidate including “double-sided”. The preview image 46 is a setting candidate including “9in1 (to print 9 images on a single sheet)” as the printing condition.

The simple setting screen may be set to fix the setting candidates displayed in the initial screen or may vary depending on the user's use frequency. In the initial screen of the simple setting screen, it is assumed that the default setting candidate (for example, the setting candidate of “No change” as shown in FIG. 2) in the initial state is selected. In the initial screen of the simple setting screen, the user selects the preview image of the setting candidate including the setting conditions closest to the setting details desired by himself by the use of the touch panel 12b.

If one setting candidate is selected in the simple setting screen, the processor 21 generates new setting candidates on the basis of the setting candidate selected in a setting candidate generating process to be described later. If generating the new setting candidates on the basis of the setting candidate selected by the user, the processor 21 displays a list of the generated setting candidates on the display unit 12a. Accordingly, the simple setting screen updates its display details. That is, whenever the user selects one setting candidate in the simple setting screen, the display unit 12a displays new setting candidates, which are generated on the basis of the setting candidate selected by the user, similar to the selected setting candidate.

In the example of the simple setting screen shown in FIG. 2, it is assumed that the user selects the preview image 42 which represents the setting candidate including “2in1, double-sided, stapling” as the printing conditions. In this case, the processor 21 generates new setting candidates similar in printing conditions to the setting candidate of the preview image 42 on the basis of the printing conditions including “2in1, double-sided, stapling” as printing conditions for the setting candidate selected by the user.

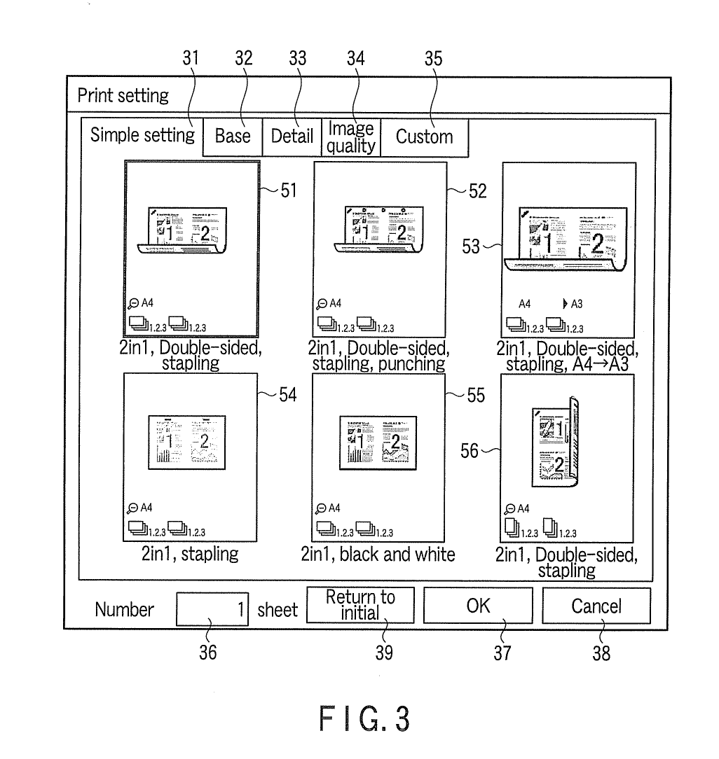

FIG. 3 is a diagram illustrating an example where plural setting candidates generated on the basis of the printing conditions including “2in1, double-sided, stapling” shown in FIG. 2.

In the example shown in FIG. 3, the preview image 51 (42) selected in the simple setting screen shown in FIG. 2 by the user is displayed in a selected state and preview images 52 to 56 as plural setting candidates generated on the basis of the printing conditions including “2in1, double-sided, stapling” are displayed. In the example of the simple setting screen shown in FIG. 3, a “return” button 39 for instructing to return to the initial screen is also displayed in addition to the display frame 36 representing the number of printed matters, the “OK” button 37, and the “cancel” button 38.

In the setting candidate of the preview image 42, it is assumed that the double-sided setting is “folding in long side”. The “folding in long side” is a double-sided print in which it is assumed that a long side of a sheet which is an upper (lower) side is vertically folded (opened), as indicated by the preview image 42 in FIG. 2. For example, in the preview image 42 shown in FIG. 2, two vertically-longitudinal (portrait) images are arranged horizontally on a single sheet of which the longitudinal direction is horizontal, as an example of the folding in long side. The double-sided setting includes “folding in short side”. The “folding in short side” is a double-sided print in which it is assumed that a short side of a sheet which is an upper (lower) side is horizontally folded (opened), as indicated by the preview image 56 in FIG. 3. For example, in the preview image 56 shown in FIG. 3, two horizontally-longitudinal (landscape) images are arranged vertically on a single sheet of which the lateral direction is horizontal, as an example of the folding in short side.

The preview image 52 is a setting candidate including “2in1, double-sided (folding in long side), stapling, punching” as the printing conditions. The preview image 53 is a setting candidate including “2in1, double-sided (folding in long side), stapling, A4->A3” as the printing conditions. The preview image 54 is a setting candidate “2in1, stapling” as the printing conditions. The preview image 55 is a setting candidate including “2in1, black and white” as the printing conditions. The preview image 56 is a setting candidate including “2in1, double-sided (folding in short side), stapling” as the printing conditions.

The preview images 52 to 56 shown in FIG. 3 are generated on the basis of the printing conditions in the setting candidate of the preview image 42. Accordingly, the printing conditions in the setting candidates of the preview images 52 to 56 are similar to those of the setting candidate of the preview image 42. This is because the processor 21 generates the setting candidates including the printing conditions similar to the printing conditions in the setting candidate of the preview image 42 selected by the user.

For example, the setting candidates of the preview images 52 to 56 include “2in1” as the printing condition, similarly to the setting candidate of the preview image 42. The preview image 52 is a setting candidate including “punching” in addition to the printing conditions of the setting candidate of the preview image 42. The preview image 53 is a setting candidate including “A4->A3” in addition to the printing conditions of the setting candidate of the preview image 42. The preview image 54 is a setting candidate obtained by deleting “double-sided” (changing “double-sided” to “one-sided” from the printing conditions of the setting candidate of the preview image 42. The preview image 55 is a setting candidate obtained by deleting “double-sided” from the printing conditions of the setting candidate of the preview image 42 and adding “black and white” (changing “color” to “black and white”). The preview image 56 is a setting candidate obtained by changing “double-sided (folding in long side)” to “double-sided (folding in short side)” in the printing conditions of the setting candidate of the preview image 42.

In the above-mentioned simple setting screen, the user selects a preview image as the setting candidate close to the desired printing conditions. Accordingly, plural setting candidates including the printing conditions similar to the printing conditions selected by the user are displayed in the simple setting screen. If the setting candidates of the printing conditions desired by the user are displayed in this way, the user touches the “OK” button 37 in the state where the preview image as the desired setting candidate is selected. Accordingly, the processor 21 determines the printing conditions of the selected setting candidate as the print setting details and performs the print setting on the basis of the printing conditions of the selected setting candidate.

The setting candidates displayed by the preview images in the simple setting screen will be described below.

In the first embodiment of the invention, seven setting conditions of “Nin1”, “double-sided”, “stapling”, “punching”, “color”, “printing direction”, and “magnification” are exemplified as settable conditions. The “Nin1” is a function of arranging and printing N images on a single sheet. The “stapling” is a function of stapling sheets on which images are printed. The “punching” is a function of punching sheets on which images are printed.

It is assumed that the following setting details can be selected in the above-mentioned printing conditions.
Nin1: 1, 2, 4, 9, 16
Double-sided: none, folding in long side, folding in short side
Stapling: none, one location in left-upper side, one location in right-upper side, two locations in upper side, two locations in left side
Punching: none, upper, left
Color: auto, color, bicolor, black and white
Printing direction: vertical, horizontal
Magnification: equal, smaller by one step, greater by one step

That is, in the example, one of “1in1 (no setting in Nin1, default), 2in1, 4in1, 9in1, and 16in1” is selected as the setting of “Nin1”. As the setting of “double-sided”, one of “none (one-sided, default), folding in long side, and folding in short side”. As the setting of “stapling”, one of “none (default), one location in left-upper side, one location in right-upper side, two locations in upper side, and two locations in left side” is selected. As the setting of “punching”, one of “none (default), upper, and left” is selected. As the setting of “color”, one of “auto (automatic selection of color or black and white, default), color, bicolor, and black and white” is selected. As the setting of “printing direction”, one of “vertical (default) and horizontal” is selected. As the setting of “magnification”, one of “equal (equal magnification, default), smaller by one step (for example, A3->A4), and greater by one step (for example, A4->A3)” is selected.

As described above, the digital multi-function peripheral 1 has plural types of conditions which can be set. The number of settable conditions increases as the number of functions of the digital multi-function peripheral 1 increases. As the number of settable conditions increases, the number of combinations of conditions (that is, the number of setting candidates) increases. In this embodiment, the setting candidates including combinations of plural types of conditions are expressed by vectors.

For example, the setting candidate including a combination of n conditions is expressed by a n-dimensional vector including n parameters representing n conditions.

The setting candidate expressed by the n-dimensional vector is displayed as a preview image indicating the printing conditions on the display unit 12a. The preview image serves as a touch button which can be selected in the touch panel 12b. The preview image is generated on the basis of the n printing conditions in the setting candidates. If the user selects one preview image as one setting candidate, the processor 21 newly generates a vector “close in distance” to the vector representing the combination of the printing conditions in the setting candidate of the selected preview image. That is, the processor 21 has a function of generating a vector “close in distance” to the selected vector on the basis of the vector of the selected setting candidate. For example, the processor 21 generates the vector “close in distance” to the selected vector by changing some parameters of the selected vector. The vector close in distance to the vector of the selected setting candidate represents the setting candidate of the printing conditions similar to those of the selected setting candidate.

The processor 21 generates plural vectors “close in distance” to the vector of the selected setting candidate. This means that plural setting candidates having the printing conditions similar to those of the selected setting candidate are generated. If generating plural vectors “close in distance” to the selected vector, the processor 21 displays the preview image of the setting candidate represented by the selected vector and the preview images of the plural setting candidates represented by the plural vectors generated on the basis of the selected vector on the display unit 12a.

That is, whenever one setting candidate is selected, the processor 21 generates new setting candidates having the printing conditions similar to those of the selected setting candidate and displays the preview images of the generated setting candidates on the display unit 12a. Accordingly, the user can retrieve the setting candidate having desired printing conditions by selecting the preview images of the setting candidates including plural types of combinations of printing conditions. As a result, the user poor at the operation can easily set the desired printing conditions.

A vector representing a combination of printing conditions will be described in detail below.

Here, it is assumed that each setting candidate includes seven printing conditions described above and is expressed by a seven-dimensional vector.

First, it is assumed that setting details of “Nin1”, “double-sided”, “stapling”, “punching”, “color”, “printing direction”, and “magnification” are represented by parameters p1, p2, p3, p4, p5, p6, and p7. It is also assumed that the parameters p1, p2, p3, p4, p5, p6, and p7 of the printing conditions have values representing the above-mentioned setting details. Then, the parameters p1, p2, p3, p4, p5, p6, and p7 representing the printing conditions have the following values.
P1ε{1, 2, 4, 9, 16}
P2ε{1, 1, 2}
P3ε{0, 1, 2, 3.4}
p4ε{0, 1, 2}
p5ε{0, 1, 2, 3}
p6ε{0, 1}
p7ε{−1, 0, 1}

In the above-mentioned example, as the setting of “Nin1”, the values representing “1in1, 2in1, 4in1, 9in1, and 16in1” are designed to “1, 2, 4, 9, and 16”, respectively. In this case, the parameter p1 representing “Nin1” is one of 1, 2, 4, 6, 9, and 16. The parameter p1 representing the setting details of Nin1 has a value corresponding to the number of images printed on a single sheet and is a scale (ordinal scale) meaningful in magnitude of the numerical value. The parameter p1 may be a value (ordinal scale) representing the magnitude of the number of images printed on a single sheet with Nin1. For example, 1in1, 2in1, 4in1, 9in1, and 16in1 of the parameter p1 may be designed to 1, 2, 3, 4, and 5, respectively.

In the above-mentioned example, the values representing “smaller by one step, equal, and greater by one step” as the setting of “magnification” are designed to “−1, 0, and 1”. In this case, the parameter p7 representing the “magnification” is one of −1, 0, and 1. The parameter p7 representing the setting details of the magnification is a value representing the changed value of magnification and is a scale (ordinal scale) meaning in magnitude of the numerical values. The “magnification” may be set to real values of 0% to 400%. In this case, the parameter p7 representing the “magnification” may be a continuous scale which is one of 0, 1, . . . , 399, and 400.

In the above-mentioned example, the values representing “none, folding in long side, and folding in short side” as the setting of “double-sided” are designed to “0, 1, and 2”, respectively. In this case, the parameter p2 representing the “double-sided” is one of 0, 1, and 2. The parameter p2 representing the setting details of the double-sided is a scale (nominal scale) meaningless in magnitude of the numerical values and used to identify the setting details.

In the above-mentioned example, the values representing “none, one location in left-upper side, one location in right-upper side, two locations in upper side, and two locations in left side” as the setting of “stapling” are designed to “0, 1, 2, 3, and 4”, respectively. In this case, the parameter p3 representing the “stapling” is one of 0, 1, 2, 3, and 4. The parameter p3 representing the setting details of the stapling is a scale (nominal scale) meaningless in magnitude of the numerical values and used to identify the setting details.

In the above-mentioned example, the values representing “none, upper, and left” as the setting of “punching” are designed to “0, 1, and 2”, respectively. In this case, the parameter p4 representing the “punching” is one of 0, 1, and 2. The parameter p4 representing the setting details of the punching is a scale (nominal scale) meaningless in magnitude of the numerical values and used to identify the setting details.

In the above-mentioned example, the values representing “auto, color, bicolor, and black and white” as the setting of “color” are designed to “0, 1, 2, and 3”, respectively. In this case, the parameter p5 representing the “color” is one of 0, 1, 2, and 3. The parameter p5 representing the setting details of the color is a scale (nominal scale) meaningless in magnitude of the numerical values and used to identify the setting details.

In the above-mentioned example, the values representing “vertical and horizontal” as the setting of “printing direction” are designed to “0 and 1”, respectively. In this case, the parameter p6 representing the “printing direction” is one of 0 and 1. The parameter p6 representing the setting details of the printing direction is a scale (nominal scale) meaningless in magnitude of the numerical values and used to identify the setting details.

However, the parameters p2 to p6 representing the printing conditions of “double-sided”, “stapling”, “punching”, “color”, and “printing direction” may be set to values in the ordinal scale in consideration of similarity of the setting details. For example, in the setting of “double-sided”, it may be considered that the double-sided printing or not is a great difference and the folding in long side or the folding in short side is not a great difference. According to this consideration, the parameter p2 representing the “double-sided” may be set so that the distance between the none (one-sided) and the double-sided (folding in long side and folding in short side) is great and the distance between the folding in long side and the folding in short side is small. For example, “none”, “folding in long side”, and “folding in short side” of the parameter p2 representing the “double-sided” may be designed to “0”, “1”, and “1.1”, respectively. The parameter (for example, p2ε{0, 1, 1.1}) designed in this way may be defined as an ordinal scale.

An example where the vectors of the setting candidates including the combinations of the above-mentioned parameters are generated will be described below.

As described above, the setting candidates including the combinations of plural printing conditions are expressed by vectors including the parameters representing the printing conditions. For example, if the setting candidate of the preview image 42 including “2in1, double-sided (folding in long side), and stapling” shown in FIG. 2 is P1, P1=(2, 1, 1, 0, 0, 0, −1) is expressed.

If the preview image 42 (vector P1) shown in FIG. 2 is selected, the preview images 51 to 56 shown in FIG. 3 are displayed on the display unit 12a. The vectors P11 to P16 of the setting candidates of the preview images 51 to 56 shown in the example of FIG. 3 are expressed as follows.
P11=(2, 1, 1, 0, 0, 0, −1)
P12=(2, 1, 1, 0, 0, −1)
P13=(2, 1, 0, 0, 0, 0)
P14=(2, 0, 3, 0, 0, 0, −1)
P15=(2, 0, 0, 0, 3, 0, −1)
P16=(2, 1, 1, 0, 0, 1, −1)

As described above, in the example shown in FIG. 3, it can be seen that the vector P11 is the same as the vector P1 of the selected setting candidate and the setting candidates of the vectors P12 to P16 are similar to the vector P1 (P11). For example, the vectors P12, P13, and P16 are obtained by changing only one parameter value of the vector P11 (P1). The vector P14 is obtained by changing two parameter values of the vector P11 (P1). The vector P15 is obtained by changing three parameter values of the vector P11 (P1). The vector P15 is obtained by changing two parameter values of the vector P14.

That is, in the above-mentioned simple setting screen, the user selects the setting candidate closest to the desired printing conditions. If the user selects the setting candidate of the vector P1, the processor 21 generates plural vectors close in distance to the selected vector P1 and provides the generated vectors as next setting candidates. The method of generating the vectors close to the vector P1 can employ a genetic algorithm.

For example, if the setting candidates are the above-mentioned seven-dimensional vectors, one or more parameters are randomly selected from the seven parameters p1 to p7 of the vectors and the values of the selected parameters are changed, whereby a new vector is generated. In this case, as the number of parameters of which the value should be changed becomes smaller, the vector closer in distance can be generated.

If the parameter (changed parameter) of which the value should be changed is an ordinal scale or a continuous scale, the value of the changed parameter is changed to a value close to the parameter value in the vector of the selected setting candidate. For example, the value of the changed parameter as the ordinal scale or the continuous scale may be changed to a value adjacent to the parameter value of the vector of the selected setting candidate or may be changed to a value randomly selected in the vicinity (for example, in the range of ±2) of the parameter value of the vector of the selected setting candidate. If the parameter of which the value should be changed is a nominal scale, the value of the changed parameter may be changed to a randomly-selected value.

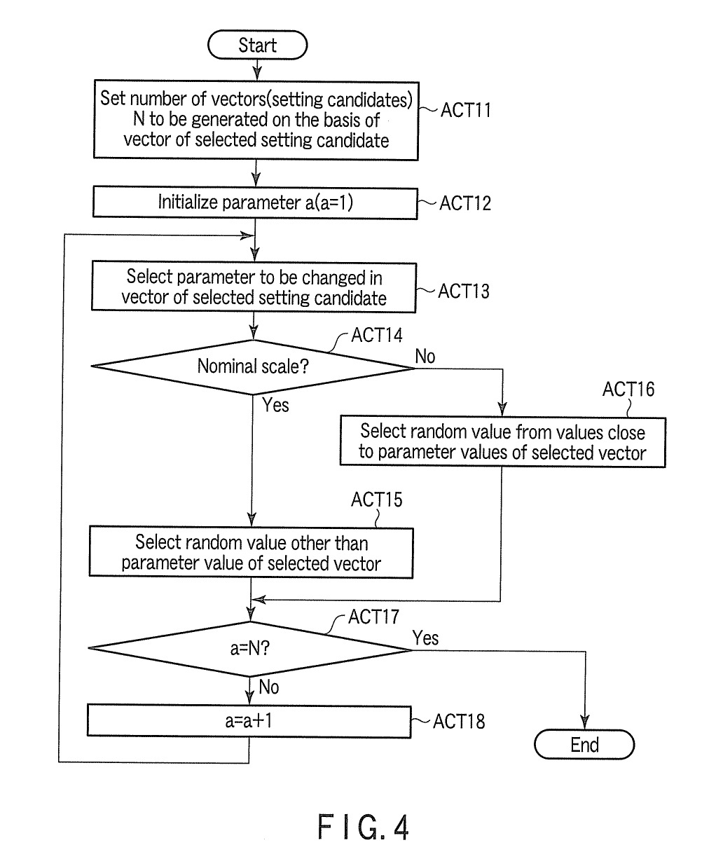

FIG. 4 is a flowchart illustrating a flow of processes of generating a setting candidate group of vectors close in distance to the vector of the selected setting candidate.

Here, it is assumed that a vector as a setting candidate is selected by the use of the operation panel 12. If one setting candidate is selected, the processor 21 performs the new setting candidate generating process on the basis of the selected setting candidate. First, the processor 21 determines the number of vectors (here, N) as the setting candidates to be generated on the basis of the vector of the selected setting candidate (ACT11). The number of setting candidates to be generated on the basis of the selected setting candidate may be a predetermined number or may be set by the user.

If the number of setting candidates (N) to be generated is determined, the processor 21 sets parameter a to an initial value (a=1) (ACT12). If parameter a is set or updated, the processor 21 generates the vector of the a-th setting candidate. The processor 21 generates the a-th vector by changing some parameter values of the vector of the selected setting candidate (ACT13 to ACT16).

That is, in the process of generating the a-th vector, the processor 21 first selects the parameter (changed parameter) to be changed in the vector of the selected setting candidate (ACT13). The number of changed parameters may be one or more. The changed parameter may be randomly selected or may be selected on the basis of the user's use frequency. Here, it is assumed that a randomly-selected parameter is changed. If the number of changed parameters is two or more, the processor 21 can repeatedly perform the processes of ACT14 to ACT16 by the number of changed parameters.

If the changed parameter is selected, the processor 21 determines whether the changed parameter is a nominal scale (ACT14). If it is determined that the changed parameter is an ordinal scale or a continuous scale (NO in ACT14), the processor 21 randomly selects a value from the values close to the parameter value in the vector of the selected setting candidate as the value of the changed parameter (ACT16). For example, if the changed parameter is the ordinal scale or the continuous scale, the processor 21 selects a value adjacent to the parameter value in the vector of the selected setting candidate.

If it is determined that the changed parameter is the nominal scale (YES in ACT14), the processor 21 selects, as a value of the changed parameter, a random value other than the parameter value in the vector of the selected setting candidate (ACT15). If the value of the changed parameter is selected, the processor 21 generates the vector obtained by changing the value of the parameter in the vector of the selected setting candidate to the value of the selected changed parameter as the a-th setting candidate.

If the vector as the a-th setting candidate is generated, the processor 21 determines whether parameter a reaches to the number of setting candidates (N) to be generated (ACT17). If parameter a does not reach the number of setting candidates to be generated (YES in ACT17), the processor 21 increases the value of parameter a (ACT18) and performs again the processes from ACT13. If parameter a reaches the number of setting candidates (N) to be generated (YES in ACT17), the processor 21 sets the generated N vectors as N new setting candidates generated on the basis of the selected setting candidate and ends the flow of process.

By performing the above-mentioned flow of processes, it is possible to generate N vectors close in distance to the vector of the selected setting candidate on the basis of the vector of the selected setting candidate. The N vectors are vectors representing the N setting candidates similar to the selected setting candidate. Therefore, by performing the above-mentioned flow of process, it is possible to provide N setting candidates similar to the selected setting candidate.

The setting candidate selecting process in the simple setting screen will be described below.

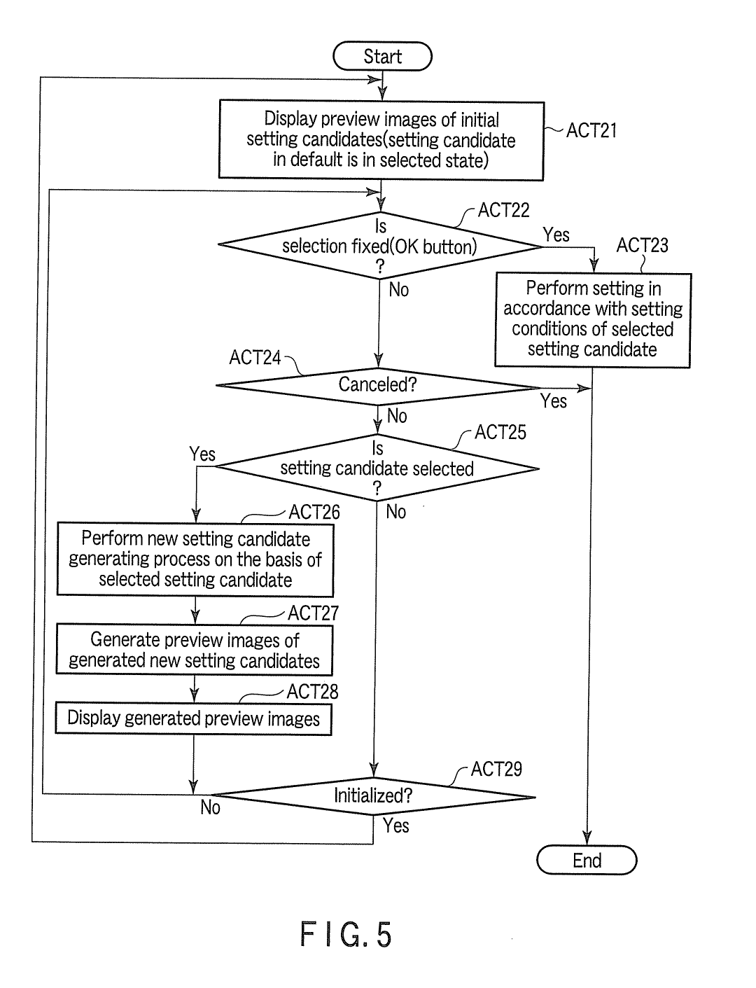

FIG. 5 is a flowchart illustrating a flow of the setting candidate selecting process.

First, if the “simple setting” tab is selected on the display unit 12a of the operation panel 12, the processor 21 displays the preview images of plural initial setting candidates as an initial picture of the simple setting screen shown in FIG. 2 (ACT21). In the initial picture of the simple setting screen, the setting candidate (not changed) of which all the printing conditions are set to defaults is displayed in a selected state. The setting candidate (initial setting candidates) displayed in the initial picture of the simple setting screen may be stored in advance in the data memory 26 or may be generated on the basis of one initial setting candidate of which all the printing conditions are set to defaults.

In the state where the simple setting screen is displayed, the processor 21 senses the input to the buttons and the tabs (which are the buttons if the buttons and the tabs are common). For example, in the state where the simple setting screen is displayed, the processor 21 determines whether the “OK” button is selected (ACT22). If the “OK” button is selected in the simple setting screen (YES in ACT22), the processor 21 fixes the selection of the setting candidate in the selected state. For example, if the simple setting screen is the print setting, the processor 21 performs the print setting with the printing conditions of the setting candidate selected by the instruction to the “OK” button (ACT23).

If the “OK” button is not selected (NO in ACT22), the processor 21 determines whether the “cancel” button is selected (ACT24). If the “cancel” button is selected (YES in ACT24), the processor 21 ends the flow of processes without performing any process and updates the display screen of the display unit 12a to the initial screen (standby screen). If the “cancel” button is not selected (NO in ACT24), the processor 21 determines whether one of the preview images displayed as the setting candidates is selected (ACT25).

If one preview image is selected (YES in ACT25), the processor 21 performs a process of generating plural new setting candidates on the basis of the setting candidate of the selected preview image (ACT26). The process of generating the new setting candidates is performed, for example, in the same way as described with reference to FIG. 4. If the new setting candidates are generated on the basis of the selected setting candidate, the processor 21 as the generator generates the preview images representing the printing conditions in the newly-generated setting candidates (ACT27). If the preview images of the setting candidates are generated, the processor 21 as the display controller updates the display details of the simple setting screen by displaying the generated preview images on the display unit 12a (ACT28). If the display details are updated, the processor 21 repeatedly performs the above-mentioned flow of processes again in ACT22.

If the preview images are not selected (NO in ACT25), the processor 21 determines whether the “return to initial” button is selected (ACT29). If the “return to initial” button is selected (YES in ACT29), the processor 21 displays again the initial picture of the simple setting screen shown in FIG. 2 on the display unit 12a in ACT21. If the “return to initial” button is not selected (NO in ACT29), the processor 21 senses the input to the buttons in ACT22 again.

In the above-mentioned processes, whenever the user selects a setting candidate, the preview images representing the printing conditions of the new setting candidates generated on the basis of the selected setting candidate are displayed. Accordingly, the user can visually and easily retrieve the setting candidate having the desired setting conditions by selecting the preview images of the setting candidates close to the desired setting details.

A second embodiment of the invention will be described below.

The second embodiment is a modified example of the first embodiment. The second embodiment can be embodied by the same hardware configuration shown in FIG. 1 and described in the first embodiment. In the second embodiment, it is possible to embody the same functions as described in the first embodiment as the basic functions.

In the second embodiment, the setting candidates are provided by objects in the simple setting screen.

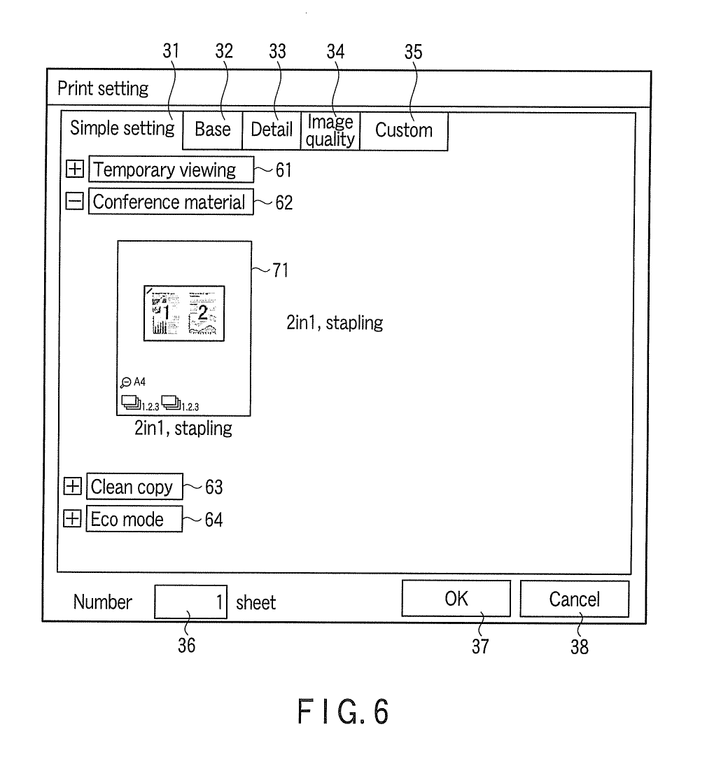

FIG. 6 is a diagram illustrating an example of the simple setting screen for the print setting according to the second embodiment of the invention. FIG. 6 shows a first example of the object simple setting screen. As shown in FIG. 6, in the second embodiment, plural object items 61 to 64 which can be selected in the touch panel 12b are displayed in the simple setting screen. In the example shown in FIG. 6, the “conference material” 62 is selected from the object items 61 to 64. In the example shown in FIG. 6, if the “conference material” 62 is selected, a setting candidate of the printing conditions including “2in1 and stapling” is displayed as a preview image 71 as an initial setting candidate used for the conference material. The setting candidate displayed as the initial setting candidate may be set in advance or may be changed depending on the user's use frequency.

If it is desired to perform a print job with the printing conditions of the object initial setting candidate, the user selects the “OK” button 37 by the use of the touch panel 12b in the state where the object initial setting candidate is displayed on the display unit 12a. If the “OK” button 37 is selected in the state where the object initial setting candidate is displayed, the processor 21 performs the print setting on the basis of the printing conditions of the initial setting candidate.

If it is desired to change the printing conditions of the initial setting candidate, the user selects the preview image of the initial setting candidate displayed on the display unit 12a by the use of the touch panel 12b. If the preview image of the initial setting candidate is selected, the processor 21 performs the process of generating new setting candidates on the basis of the selected object initial setting candidate, similarly to the first embodiment. If the new setting candidates are generated, the processor 21 generates the preview images of the generated setting candidates and displays the generated preview images in the object simple setting screen. In this way, the setting candidate selecting process described in the first embodiment can be carried out on the preview images displayed in the object simple setting screen.

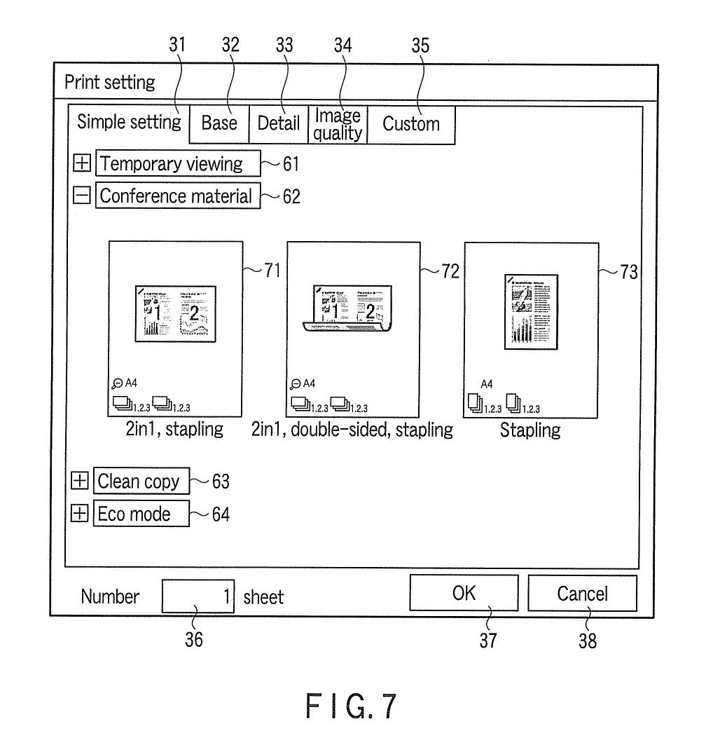

FIG. 7 is a second example of the object simple setting screen. In the second example shown in FIG. 7, the plural initial setting candidates are displayed in the preview images 71 to 73 in the object initial simple setting screen. As shown in FIG. 7, the plural initial setting candidates displayed in the object initial simple setting screen may be set in advance or may be changed depending on the user's use frequency.

If the plural initial setting candidates are displayed in the object initial simple setting screen, the processor 21 generates new setting candidates on the basis of the setting candidate selected by the user from the plural setting candidates and displays the preview images of the generated setting candidates in the object simple setting screen.

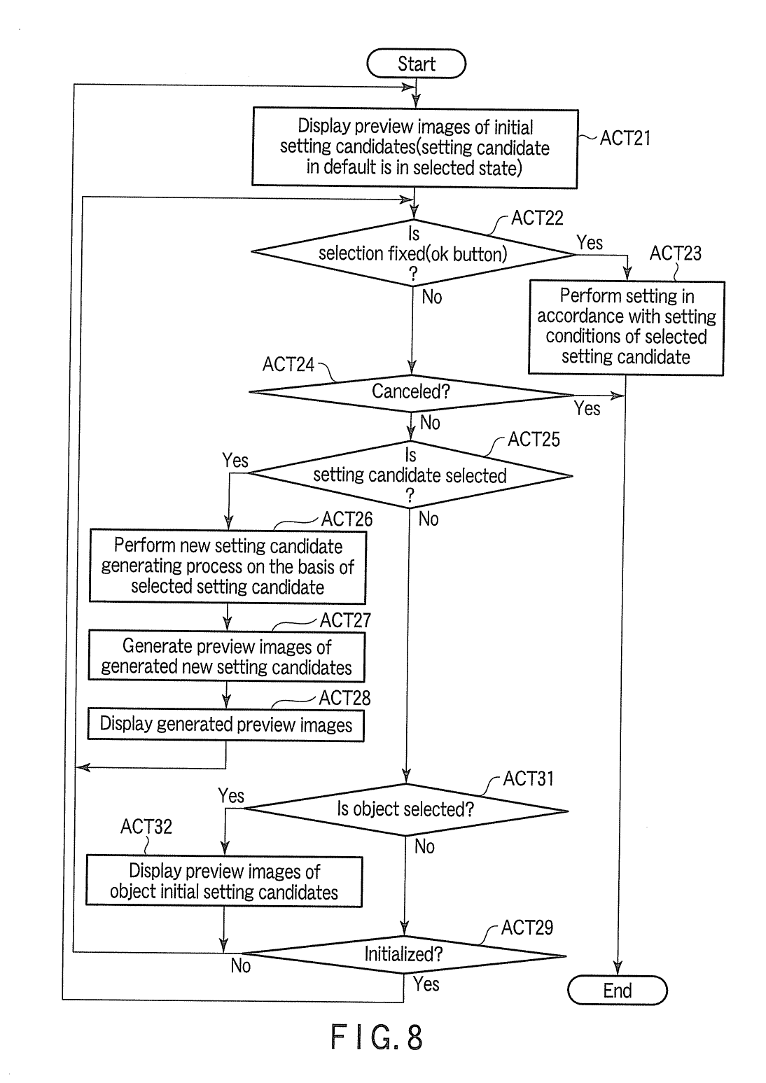

For example, FIG. 8 is a flowchart illustrating a flow of the setting candidate selecting process in the object simple setting screen. The flow of processes shown in the flowchart of FIG. 8 is obtained by adding the process of displaying the simple setting screen by the object selected by the user to the flow of processes shown in the flowchart of FIG. 5 and described in the first embodiment. Accordingly, the same processes as shown in FIG. 5 will be denoted by the same reference numerals and signs and will not be described in detail.

First, the processor 21 displays the preview images of the initial setting candidates for the default object in the object initial simple setting screen as the process of ACT 21 in the second embodiment. In the object initial simple setting screen, as shown in FIG. 6 or 7, object items 61 to 64 which can be selected by the user are displayed in addition to the “OK” button 37, the “cancel” button 38, and the preview images 71 to 73. If one of the “OK” button 37, the “cancel” button 38, and the preview images 71 to 73 is selected by the user in the object simple setting screen shown in FIG. 6 or 7, the processor 21 performs the processes of ACT22 to ACT28.

If one of the object items 61 to 64 is selected by the user in the object simple setting screen (YES in ACT31), the processor 21 displays the preview image of the initial setting candidate corresponding to the object selected by the user on the display unit 12a (ACT32). The object simple setting screen displaying the preview image of the initial setting candidate corresponding to the object selected by the user includes, for example, the display details shown in FIG. 6 or 7. If the preview image of the initial setting candidate corresponding to the object selected by the user is displayed, the “return to initial” for returning to the display details displayed in ACT21 may be displayed on the display unit 12a.

As described above, in the second embodiment, it is possible to provide the initial setting candidate corresponding to the object selected by the user to the object simple setting screen. If the user selects the setting candidate in the object simple setting screen, setting candidates of the printing conditions close to those of the setting candidate selected by the user can be provided.

In the first and second embodiments, the simple setting example for the print setting is described. However, the first and second embodiments are not limited to the print setting, but the same simple setting can be applied to copy setting or scan setting. In the first and second embodiments, the process of selecting the setting candidate in the operation panel 12 of the digital multi-function peripheral 1 is described. However, the process of selecting the setting candidate using the simple setting screen described above may be embodied by a processor of a personal computer in which a printer driver is installed.

A third embodiment of the invention will be described below.

The third embodiment is a modified example of the first embodiment. The digital multi-function peripheral 1 according to the third embodiment can be embodied by the same hardware configuration as shown in FIG. 1 and described in the first embodiment. Accordingly, in the third embodiment, the same elements as described in the first embodiment will not be repeatedly described.

In the third embodiment, an example of an image quality correction (image quality adjustment) setting process in the print setting will be described.

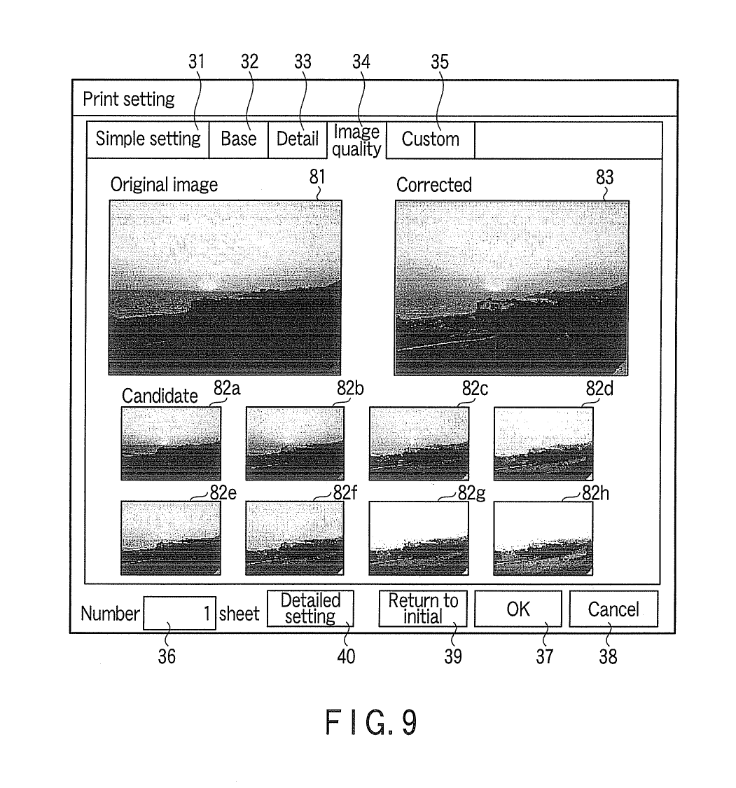

FIG. 9 is a diagram illustrating an example of an image quality setting screen in the print setting.

The image quality setting screen is displayed if the “image quality” tab 34 displayed on the display unit 12a is selected. For example, if the “image quality” tab 34 is selected in the simple setting screen shown in FIG. 2, the image quality setting screen shown in FIG. 9 is displayed on the display unit 12a. In the example of the image quality setting screen shown in FIG. 9, an original image 81, plural preview images 82a to 82h obtained by correcting the original images in accordance with the printing conditions (image quality setting conditions) of plural setting candidates (image quality setting candidates), and a corrected image 83 obtained by correcting the original image in accordance with the setting conditions of the image quality setting candidate in the selected state are displayed on the display unit 12a.

In the example shown in FIG. 9, plural tabs such as the “simple setting” tab 31, the “base” tab 32, the “details” tab 33, the “image quality” tab 34, and the “custom” tab 35 are displayed and the “image quality” tab 34 is in the selected state. In the image quality setting screen, the display frame 36 representing the number of print matters, the “OK” button 37 for instructing to fix the selected details, the “cancel” button 38 for instructing to cancel the selected details, the “return to initial” button 39 for instructing to return to the initial screen, and a “detailed setting” button 40 for instructing to move to a detailed setting screen are displayed.

In the initial screen for the image quality setting, the original image and the preview images obtained by correcting the original image in accordance with predetermined image quality setting candidates (initial image quality setting candidates) are displayed on the display unit 12a. The number of initial image quality setting candidates displayed in the initial screen for the image quality setting is two or more. Accordingly, plural images corrected in accordance with the plural setting candidates are displayed as the preview images in the initial screen for the image quality setting. The initial image quality setting candidates displayed in the initial screen may be set in advance as the image process setting by objects such as photograph or text, or may be changed depending on the user's use frequency.

For example, it is assumed that a subject in a dark part is not known since the original image is dark as a whole. If such an original image is printed out, the user desires to correct the image so that the subject in the dark part of the original image becomes clear. However, the user poor at the operation may not know what image quality setting condition to change or how to change set values or may spend much time in the image quality adjustment.

In this case, in the image quality setting screen shown in FIG. 9, the user can select one favorite preview image from the plural preview images obtained by correcting the original image in accordance with the setting conditions of the plural image quality setting candidates.

If the user selects one setting candidate from the preview images (setting candidates), the processor 21 displays the corrected image in accordance with the image quality setting conditions of the selected setting candidate and displays new setting candidates, which are generated on the basis of the selected setting candidate, as the preview images. The user selects one preview image having the desired image quality from the preview images of the image quality setting candidates and presses the “OK” button. Accordingly, the user can visually and easily set the desired image quality adjustment.

Whenever one preview image is selected in the image quality setting screen, the processor 21 displays setting candidates generated on the basis of the selected setting candidate as the preview images. Accordingly, the user can retrieve the setting candidate having the desired image quality by only selecting the preview images of the image quality setting candidates, and a user poor at the image quality adjustment can easily perform the desired image quality adjustment.

An example of the image quality setting process according to the third embodiment will be described below.

The process of generating the new setting candidates on the basis of the selected setting candidate can employ the process described with reference FIG. 4 in the first embodiment. However, the third embodiment is different from the first embodiment, in settable conditions (parameters). For example, in the image quality adjustment, “fine line”, “halftone”, “concentration C”, “concentration M”, “concentration Y”, “concentration K”, “sharpness”, “brightness”, “contrast”, and “saturation” are considered as the image quality setting conditions. Here, ten conditions of “fine line”, “halftone”, “concentration C”, “concentration M”, “concentration Y”, “concentration K”, “sharpness”, “brightness”, “contrast”, and “saturation” will be described as the image quality setting conditions.

The “fine line” is to set whether an image correction for printing fine lines clear should be performed. The “halftone” is to set a gray scale. The “concentration C”, the “concentration M”, the “concentration Y”, and the “concentration K” are to set concentrations of colors (cyan C, magenta M, yellow Y, and black K) for color print, respectively. The “sharpness” is to set a degree of emphasis of an outline. The “brightness” is to set the brightness. The “contrast” is to set a difference between darkness and brightness. The “saturation” is to set the clearness of color.

The setting of “fine line” is to select one of ON and OFF. The setting of “halftone” is to select one of “auto, smooth, and detail”. The settings of “concentration C”, “concentration M”, “concentration Y”, “concentration K”, “sharpness”, “brightness”, “contrast”, and “saturation” are to select one value in the range of −10 to 10. Here, parameters representing “fine line”, “halftone”, “concentration C”, “concentration M”, “concentration Y”, “concentration K”, “sharpness”, “brightness”, “contrast”, and “saturation” are q1, q2, . . . q10. Then, the parameters q1, q2, . . . , q10 representing “fine line”, “halftone”, “concentration C”, “concentration M”, “concentration Y”, “concentration K”, “sharpness”, “brightness”, “contrast”, and “saturation” have the following values.
Fine line: q1ε{0, 1}
Halftone: q2ε{0, 1, 2}
Concentration C: −10≦q3≦10
Concentration M: −10≦q4≦10
Concentration Y: −10≦q5≦10
Concentration K: −10≦q6≦10
Sharpness: −10≦q7≦10
Brightness: −10≦q8≦10
Contrast: −10≦q9≦10
Saturation: −10≦q10≦10

The parameters q1 and q2 representing the settings of “fine line” and “halftone” among the image quality setting conditions are scales (nominal scale) meaningless in magnitude of the numerical values and used to identify the setting details. The parameters q3 to q10 representing the settings of “concentration C”, “concentration M”, “concentration Y”, “concentration K”, “sharpness”, “brightness”, “contrast”, and “saturation” among the image quality setting conditions are continuous scales having real values. The parameters q3 to q10 are real numbers of which the numerical values are directly reflected in the settings.

An image quality setting candidate including a combination of the above-mentioned ten image quality setting conditions (parameters) is expressed by a ten-dimensional vector Q=(q1, q2, . . . , q10). The vector representing the image quality setting candidate is a vector including ten parameters of nominal or continuous scales. Accordingly, in the image quality setting (image quality adjustment), the processor 21 can generate vectors of plural setting candidates (image quality setting candidates) on the basis of the vector of one setting candidate (image quality setting candidate) by applying the setting candidate generating process described with reference to FIG. 4 in the first embodiment. The setting candidate selecting process described with reference to FIG. 5 in the first embodiment can be applied to the image quality setting candidate selecting process in the image quality setting screen. However, in the third embodiment, preview images corrected from the original image in accordance with the setting conditions of the setting candidates are generated in the process of ACT27.

The image quality setting for the print setting is exemplified in the third embodiment. However, the third embodiment is not limited to the print setting, but the same image quality setting may be applied to the copy setting or the scan setting. In the third embodiment, the process of selecting the setting candidate in the operation panel 12 of the digital multi-function peripheral 1 is described. However, the process of selecting the image quality setting candidate in the above-mentioned simple setting screen may be embodied by a processor of a personal computer in which a printer driver is installed.

In the above-mentioned embodiments, the processor displays the preview images representing the setting conditions in the setting candidates including plural types of combinations of setting conditions on the display unit. Whenever one setting candidate is selected, the processor generates new setting candidates similar to the selected setting candidate on the basis of the selected setting candidate and displays the preview images of the generated setting candidates. Accordingly, whenever the user selects a preview image of a setting candidate, plural setting candidates similar to the selected setting candidate are displayed on the display unit. That is, the user can retrieve the setting candidate having the desired setting conditions from the setting candidates updated whenever a setting candidate similar to the desired setting conditions is selected. As a result, a user poor at the operation can easily set the printing conditions.

In the above-mentioned embodiment, the processor expresses the setting candidate including n setting conditions by the use of an n-dimensional vector including n parameters. Accordingly, the processor generates the setting candidates similar to the selected setting candidate by generating the vectors close in distance to the vector of the selected setting candidate.

If new setting candidates are generated, the processor determines whether the parameter of which the value should be changed is a nominal scale, randomly changes the value of the parameter of the nominal scale, and changes the value of the parameter of the ordinal scale or the continuous scale to a value (for example, adjacent value) close to the value of the parameter in the selected setting candidate. Accordingly, the processor can efficiently generate the new setting candidates similar to the selected setting candidate.

In the first, second, and third embodiments, the selection of the setting candidate in the print setting is described. However, the first, second, and third embodiments are not limited to the print setting, but may be applied to the selection of the setting candidate in the copy setting or the scan setting. In the first, second, and third embodiments, the process of selecting a setting candidate in the setting screen displayed on the display unit 12a in the operation panel of the digital multi-function peripheral is described. However, the setting candidate selecting process described in the first, second, and third embodiments may be embodied by a computer such as a personal computer having hardware components such as a processor, a memory, an interface, a display unit, and an operation unit. That is, the setting candidate selecting process described in the first, second, and third embodiments may be embodied by a printer driver installed in a computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming condition setting device comprising:
a candidate generator configured to generate a new setting candidate similar to a selected setting candidate if the setting candidate is selected from setting candidates including combinations of a plurality of types of setting conditions; and
a display controller configured to display the selected setting candidate and the new setting candidate similar to the selected setting candidate and generated by the candidate generator.

2. The device according to claim 1, further comprising a generator configured to generate preview images representing the setting conditions of the setting candidates,
wherein the display controller displays the preview image of the selected setting candidate and the preview image of the new setting candidate similar to the selected setting candidate and generated by the candidate generator.

3. The device according to claim 1, wherein the candidate generator generates as the new setting candidate a setting candidate obtained by changing one setting condition of the selected setting candidate.

4. The device according to claim 1, wherein the candidate generator expresses the setting candidates by the use of vectors representing the setting conditions with parameters and generates the vector close in distance to the vector of the selected setting candidate as the new setting candidate.

5. The device according to claim 4, wherein the candidate generator generates the vector obtained by changing one parameter value of the vector of the selected setting candidate as the new setting candidate.

6. The device according to claim 5, wherein the candidate generator changes the parameter value to a randomly-selected value if the parameter of which the value should be changed is a meaningless scale in magnitude and continuity of the value.

7. The device according to claim 5, wherein the candidate generator changes the parameter value to a value adjacent to the parameter value of the selected setting candidate if the parameter of which the value should be changed is a meaningful scale in magnitude or continuity of the value.

8. The device according to claim 1, wherein the display controller displays a selected object setting candidate among object setting candidates if an object of the setting candidate to be displayed is selected.

9. The device according to claim 1, wherein the candidate generator generates a new image quality setting candidate similar to an image quality setting candidate including a combination of a plurality of types of image quality setting conditions and being selected by the user, and
wherein the display controller displays the selected image quality setting candidate and the new image quality setting candidate similar to the selected image quality setting candidate and generated by the candidate generator on a display unit.

10. The device according to claim 9, further comprising a generator configured to generate preview images representing the setting conditions of the image quality setting candidates and generating preview images obtained by correcting an original image with the setting conditions of the image quality setting candidates,
wherein the display controller displays the original image and the preview images obtained by correcting the original image with the setting conditions of the new image quality setting candidate generated by the candidate generator.

11. An image forming condition setting method comprising:
generating a new setting candidate similar to a selected setting candidate if the setting candidate is selected from setting candidates including combinations of a plurality of types of setting conditions; and
displaying the selected setting candidate and the generated new setting candidate similar to the selected setting candidate.

12. The method according to claim 11, further comprising:
generating preview images representing the setting conditions of the setting candidates; and
displaying the preview image of the selected setting candidate and the preview image of the generated new setting candidate similar to the selected setting candidate.

13. The method according to claim 11, wherein the generating of the setting candidate comprises generating as the new setting candidate a setting candidate obtained by changing one setting condition of the selected setting candidate.

14. The method according to claim 11, wherein the setting candidates are expressed by the use of vectors representing the setting conditions with parameters and the vector close in distance to the vector of the selected setting candidate is generated as the new setting candidate.

15. The method according to claim 14, wherein the vector obtained by changing one parameter value of the vector of the selected setting candidate is generated as the new setting candidate.

16. The method according to claim 15, wherein the parameter value is changed to a randomly-selected value if the parameter of which the value should be changed is a meaningless scale in its value.

17. The method according to claim 15, wherein the parameter value is changed to a value adjacent to the parameter value of the selected setting candidate if the parameter of which the value should be changed is a meaningful scale in its value.

18. The method according to claim 11, wherein a selected object setting candidate among object setting candidates is displayed if an object of the setting candidate to be displayed is selected.

19. The method according to claim 11, wherein the generating of the setting candidate comprises:
generating a new image quality setting candidate being similar to an image quality setting candidate including a combination of a plurality of types of image quality setting conditions and being selected by the user if one of the image quality setting candidate is selected, and
displaying the selected image quality setting candidate and the generated new image quality setting candidate similar to the selected image quality setting candidate.

20. The method according to claim 19, wherein preview images representing the setting conditions of the image quality setting candidates are generated and preview images obtained by correcting an original image with the setting conditions of the image quality setting candidates are generated,
wherein the original image and the preview generated images obtained by correcting the original image with the setting conditions of the new image quality setting candidate are displayed.
